(19) United States
(12) Patent Application Publication
(10) Pub. No.: US 2024/0075608 A1
(43) Pub. Date: Mar. 7, 2024

(54) POWER TOOL WITH BEARING RETAINER

(71) Applicant: MILWAUKEE ELECTRIC TOOL CORPORATION, Brookfield, WI (US)

(72) Inventors: Ian A. Duncan, Colgate, WI (US); Miguel Ángel Ortuño Rodriguez, Querétaro (MX); Nicholas J. Losch, Hales Corners, WI (US)

(21) Appl. No.: 18/140,025

(22) Filed: Apr. 27, 2023

Related U.S. Application Data
(60) Provisional application No. 63/335,434, filed on Apr. 27, 2022.

(51) Int. Cl. B25F 5/02

(52) U.S. Cl. CPC B25F 5/02

(57) ABSTRACT

A power tool including a housing, a motor, and a bearing. The housing includes a first housing portion having a first bearing retainer portion, and a second housing portion having a second bearing retainer portion. The second housing portion is attached to the first housing portion such that the first bearing retainer portion and the second bearing retainer portion form a bearing retainer. The motor is supported within the housing. The motor includes an output shaft defining an axis. The bearing is received in the bearing retainer. The bearing is configured to support the output shaft for rotation about the axis.

### CROSS-REFERENCE TO RELATED APPLICATIONS

This application claims priority to U.S. Provisional Patent Application No. 63/335,434, filed on Apr. 27, 2022, the entire contents of which are incorporated herein by reference.

### FIELD

The present invention relates to power tools, and more particularly to bearing retainers for power tools.

### BACKGROUND

Power tools including an electric motor typically include at least one bearing for supporting an output shaft of the motor. The bearing, in turn, may be supported by a bearing retainer within a housing of the power tool. Typical bearing retainers may add to the length of the power tool or require additional components (e.g., an end cap) to be coupled to the housing to allow for insertion and desired placement of the bearing during assembly. Accordingly, a need exists for an improved bearing retainer that simplifies the construction of the housing and also reduces the overall length of the power tool.

### SUMMARY

The present invention provides, in one aspect, a power tool including a housing, a motor, and a bearing. The housing includes a first housing portion having a first bearing retainer portion, and a second housing portion having a second bearing retainer portion. The second housing portion is attached to the first housing portion such that the first bearing retainer portion and the second bearing retainer portion form a bearing retainer. The motor is supported within the housing. The motor includes an output shaft defining an axis. The bearing is received in the bearing retainer. The bearing is configured to support the output shaft for rotation about the axis.

In some aspects, each of the first housing portion and the second housing portion includes an opening formed at a position that is radially outward of the bearing retainer. In some aspects, a fan is mounted on the output shaft of the motor for rotation with the output shaft. At least a portion of the fan is located radially between the bearing retainer and the opening of each of the first housing portion and the second housing portion. In some aspects, the bearing is a rear bearing. The power tool further includes a forward bearing configured to support the output shaft on a side of the motor opposite from the rear bearing.

In some aspects, each of the first housing portion and the second housing portion I formed through molding such that the first bearing retainer portion and the second bearing retainer portion are formed through molding.

In some aspects, the first housing portion and the second housing portion form a first rear wall portion and a second rear wall portion. The first bearing retainer portion is cantilevered from the first rear wall portion. The second bearing retainer portion is cantilevered from the second rear wall portion.

In some aspects, a plurality of retainer protrusions is formed on an inner periphery of the bearing retainer. The plurality of retainer protrusions engages the bearing to mitigate noise emissions generated from rotation of the motor. In some aspects, the bearing is configured to plastically deform the plurality of retainer protrusions.

In some aspects, each of the first bearing retainer portion and the second bearing retainer portion is substantially semi-circular such that the bearing retainer is circular.

In another aspect, the invention provides a power tool including a housing, a motor, a bearing, and a bearing retainer. The motor is supported within the housing. The motor includes an output shaft defining an axis. The bearing is configured to support the output shaft for rotation about the axis. The bearing includes an outer race and an inner race. The bearing retainer defines a recess that receives the bearing. The bearing retainer includes a plurality of protrusions that extend into the recess. The outer race of the bearing is pressed into the bearing retainer such that the protrusions are plastically deformed by the outer race of the bearing.

In some aspects, each of the plurality of protrusions includes a first protrusion portion and a second protrusion portion. The second protrusion portion is angled relative to the first protrusion portion and converges toward an inner periphery of the bearing retainer.

In some aspects, the bearing retainer is cantilevered from a rear wall of the motor housing.

In some aspects, the bearing is a rear bearing, and the power tool further includes a forward bearing positioned on a side of the motor opposite from the rear bearing.

In some aspects, the housing is formed through molding such that the bearing retainer is formed through molding.

In some aspects, the power tool further includes an impact mechanism having a camshaft, a hammer, and an anvil. The camshaft is rotationally driven by the motor. The hammer is configured to reciprocate along the camshaft. The anvil is configured to receive impacts from the hammer and is configured to apply torque to a workpiece.

In another aspect, the invention provides a method of manufacturing a power tool. The method includes providing a first mold and a second mold, injection molding a polymer into the first mold to form a first housing portion, injection molding a polymer into the second mold to form a second housing portion, removing the first housing portion from the first mold and removing the second housing portion from the second mold, and attaching the first housing portion with the second housing portion. Each of the first mold and the second mold define a cavity and include a protrusion that extends through the cavity. The first housing portion includes a first bearing retainer portion formed by the protrusion of the first mold. The second housing portion includes a second bearing retainer portion formed by the protrusion of the second mold. The first bearing retainer portion and the second bearing retainer portion form a bearing retainer configured to support a bearing.

In some aspects, attaching the first housing portion with the second housing portion includes placing a bearing between the first housing portion and the second housing portion such that the first bearing retainer portion and the second bearing retainer portion form the bearing retainer around the bearing.

In some aspects, removing the first housing portion from the first mold forms an opening in the first housing portion and removing the second housing portion from the second mold forms an opening in the second housing portion. The opening of each of the first housing portion and the second housing portion is located at a position radially outward of the first bearing retainer portion and the second bearing retainer portion.

In some aspects, the method further includes providing a motor having an output shaft and a fan mounted to the output shaft, inserting the output shaft into the bearing such that the bearing supports the output shaft. The fan is mounted to the output shaft at a position such that at least a portion of the fan is located radially between the first bearing retainer portion and the opening in the first housing portion, and another portion of the fan is located radially between the second bearing retainer portion and the opening in the second housing portion.

In some aspects, injection molding a polymer into the first mold to form the first housing portion includes forming a first rear wall portion, and injection molding a polymer into the second mold to form the second housing portion includes forming a second rear wall portion such that the first bearing retainer portion and the second bearing retainer portion are cantilevered from the first rear wall portion and the second rear wall portion, respectively.

Other features and aspects of the invention will become apparent by consideration of the following detailed description and accompanying drawings.

### BRIEF DESCRIPTION OF THE DRAWINGS

FIG. 1 is a perspective view of a power tool according to an embodiment of the invention.

FIG. 2 is a cross-sectional view of the power tool of FIG. 1 taken along line 2-2 in FIG. 1, shown with a battery pack of the power tool removed.

FIG. 3 is a perspective view of a mold for forming a housing of the power tool of FIG. 1.

FIG. 4 is a perspective view of the mold of FIG. 3 after forming a first portion of the housing.

FIG. 5A is a perspective view of a portion of a rear bearing retainer integrally formed with the first portion of the housing.

FIG. 5B is a side view illustrating the portion of the rear bearing retainer of FIG. 5A.

FIG. 5C is an opposite side view illustrating the portion of the rear bearing retainer of FIG. 5A.

FIG. 5D is a perspective view illustrating assembly of a bearing into the rear bearing retainer.

FIG. 6A is a plan view of a rear bearing retainer including a plurality of retainer protrusions according to another embodiment of the disclosure.

FIG. 6B is an enhanced view of one of the plurality of retainer protrusions of FIG. 6A.

FIG. 6C is a perspective view illustrating assembly of a bearing into the rear bearing retainer.

FIG. 6D is an enhanced view illustrating engagement of the bearing with one of the plurality of retainer protrusions.

### DETAILED DESCRIPTION

The present disclosure provides, in some embodiments, a power tool, such as an impact wrench, impact driver, drill, powered screwdriver, or the like, including a housing with two clamshell halves formed via a molding process and subsequently assembled together. The housing may enclose a motor having a rotor or output shaft at least partially supported by a bearing. The bearing, in turn, may be supported within the housing by a bearing retainer. The bearing retainer may comprise two halves, each integrally formed (i.e. molded) with a respective one of the clamshell halves. In some embodiments, the mold for forming the clamshell halves may include a protrusion that extends laterally into the mold cavity to support the geometry of the bearing retainer. After molding, when the clamshell halves are removed from the mold, the protrusion may be removed through openings in the clamshell halves, which may then serve as exhaust air openings for the power tool. This mold configuration allows the bearing retainer to project forwardly from a rear wall of the housing, without any additional radial supports or a separate end cap. As such, construction of the housing can be simplified while permitting the bearing retainer to be recessed into a fan of the power tool. The overall length of the power tool may therefore be minimized.

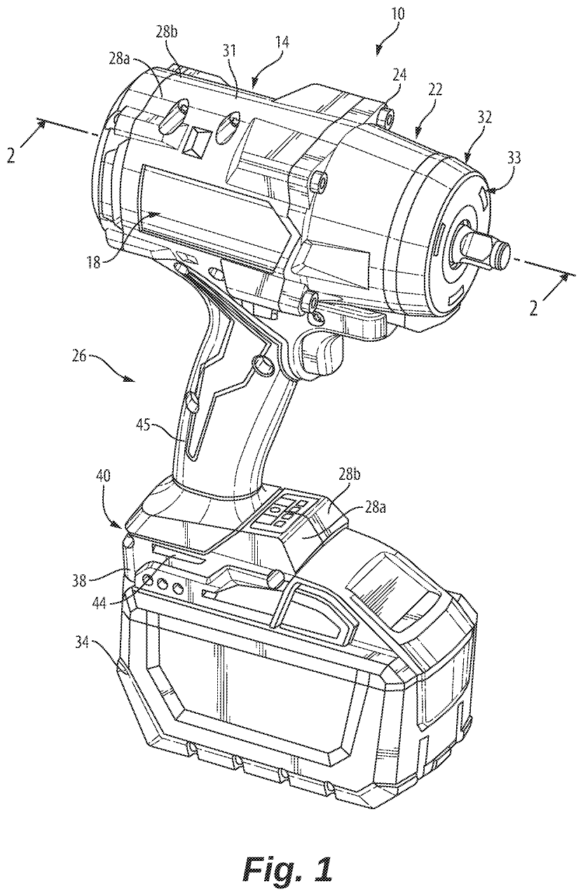

In more detail, FIG. 1 illustrates an embodiment of a power tool in the form of a rotary impact tool, and, more specifically, an impact wrench 10. The impact wrench 10 includes a housing 14 with a motor housing portion 18, an impact case or front housing portion 22 coupled to the motor housing portion 18 (e.g., by a plurality of fasteners 24), and a handle portion 26 extending downwardly from the motor housing portion 18. In the illustrated embodiment, the handle portion 26 and the motor housing portion 18 are defined by cooperating first and second clamshell halves or housing portions 28a, 28b. The clamshell halves 28a, 28b can be coupled (e.g., fastened) together at an interface or seam 31.

The impact wrench 10 further includes a lighting assembly 32 with one or more lighting sources 33. The illustrated lighting assembly 32 surrounds the front housing portion 22 and may serve as a cap at a front end of the front housing portion 22. In some embodiments, the lighting assembly 32 may include one or more lenses covering the one or more lighting sources 33. In some embodiments, the one or more lighting sources 33 may be light-emitting diodes (LEDs) arranged about a center point of the lighting assembly 32.

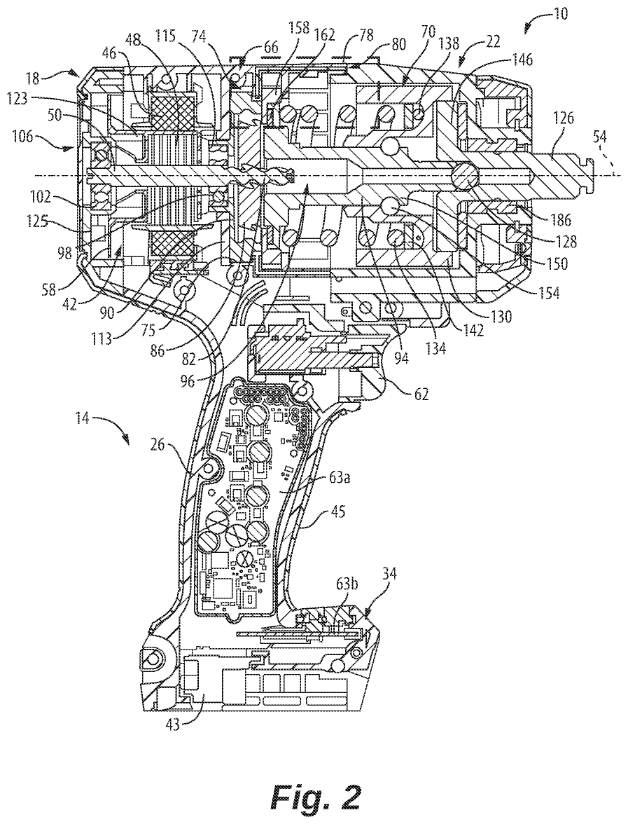

Referring to FIG. 1, the impact wrench 10 includes a battery 34 removably coupled to a battery receptacle 38 located at a bottom end or foot 40 of the handle portion 26. A motor 42 (FIG. 2) is supported within the motor housing portion 18 and receives power from the battery 34 via connections, pads, and/or battery terminals 43 supported by the battery receptacle 38 when the battery 34 is coupled to the battery receptacle 38. The foot 40 may include, as illustrated in FIG. 1, one or more vents 44 (e.g., air vents, cooling vents, etc.). In the illustrated embodiment, the handle portion 26 of the clamshell halves 28a, 28b can be covered or surrounded by a grip portion 45.

The battery 34 may be a power tool battery pack generally used to power a power tool, such as an electric drill, an electric saw, and the like (e.g., an 18 volt rechargeable battery pack, or an M18 REDLITHIUM battery pack sold by Milwaukee Electric Tool Corporation). The battery 34 may include lithium ion (Li-ion) cells. In alternate embodiments, the battery packs may be of a different chemistry (e.g., nickel-cadmium (NiCa or NiCad), nickel-hydride, and the like). In the illustrated embodiments, the battery 34 is an 18 volt battery pack. In alternate embodiments, the capacity of the battery 34 may vary (e.g., the battery may be a 4 volt battery pack, a 28 volt battery pack, a 40 volt battery pack, or a battery pack of any other voltage suitable for powering the impact wrench 10).

With reference to FIG. 2, in the illustrated embodiment, the motor 42 is a brushless direct current (“BLDC”) motor with a stator 46 and a rotor 48. The motor 42 includes an output shaft 50 that defines an axis 54 and is rotatable about the axis 54. In other embodiments, other types of motors may be used. A fan 58 is coupled to the output shaft 50 behind the motor 42 to generate airflow for cooling components of the power tool 10. In other words, the fan 58 is mounted on the output shaft 50 of the motor 42 for rotation with the output shaft 50. In the illustrated embodiment, the motor 42 is operable (e.g., controlled) without the use of Hall-Effect sensors. As such, no printed circuit board is needed adjacent the front or back end of the motor 42, allowing for a shorter length required in the housing 14 to accommodate the motor 42.

The impact wrench 10 also includes a switch 62 (e.g., a trigger switch) supported by the housing 14 that selectively electrically connects the motor 42 (e.g., via suitable control circuitry provided on one or more printed circuit board assemblies (“PCBAs”) 63a, 63b, and the battery 34, to provide DC power to the motor 42. In other embodiments, the impact wrench 10 may include a power cord for electrically connecting the switch 62 and the motor 42 to a source of AC power. As a further alternative, the impact wrench 10 may be configured to operate using a different power source (e.g., a pneumatic or hydraulic power source, etc.).

With continued reference to FIG. 2, the first PCBA 63a is positioned within the handle portion 26 and is in electrical communication with the motor 42, the switch 62, and the battery receptacle 38. In the illustrated embodiment, the first PCBA 63a includes a plurality of semi-conductor switching elements (e.g., MOSFETs, IGBTs, or the like) that control and distribute power to windings in the stator 46 in order to cause rotation of the rotor and output shaft 50. The first PCBA 63a may also include one or more microprocessors, machine-readable, non-transitory memory elements, and other electrical or electronic elements for providing operational control to the impact wrench 10. The illustrated impact wrench 10 further includes a second PCBA 62b situated in the foot 40 of the impact wrench 10. The second PCBA 62b may include one or more indicators configured to indicate an operating status or mode of the impact wrench 10. The second PCBA 62b may also include one or more communication modules (e.g., BLUETOOTH, Wi-Fi, or the like) for linking with an external device to or control the operating status or mode of the impact wrench 10.

The impact wrench 10 further includes a gear assembly 66 driven by the output shaft 50 and an impact mechanism 70 coupled to an output of the gear assembly 66. The impact mechanism 70 may also be referred to herein as a drive assembly 70. The gear assembly 66 may be configured in any of a number of different ways to provide a speed reduction between the output shaft 50 and an input of the drive assembly 70. The gear assembly 66 is at least partially housed within a gear case or gear housing 74 that is formed by the housing 14. Specifically, the clamshell halves 28a, 28b form a groove 75 that directly receives the gear assembly 66 and at least partially forms the gear housing 74. As will be described in greater detail below, the gear assembly 66 and gear housing 74 of the impact wrench 10 further reduces an overall length of the impact wrench 10.

In the illustrated embodiment, a front end portion 78 of the motor housing portion 18 receives and overlaps a part of the front housing portion 22. In the illustrated embodiment, the gear housing 74 and front housing portion 22 may contain lubricant, such as grease or oil, the assists in smooth operation of the impact wrench 10. As will be discussed in greater detail below, the impact wrench 10 further includes a sealing system 80 positioned at least partially between the gear case 74 and the front housing portion 22 to inhibit lubricant from escaping out of the front housing portion 22.

The illustrated gear assembly 66 includes a helical pinion 82 formed on the output shaft 50 of the motor 42, a plurality of helical planet gears 86 meshed with the helical pinion 82, and a helical ring gear 90 meshed with the planet gears 86 and rotationally fixed within the housing 14 (e.g., gear housing 74). A rearward facing side of the ring gear 90 is seated against a dividing wall 113 formed by the clamshell halves 28a, 28b. The dividing wall 113 separates the gear housing 74 from the motor 42.

With continued reference to FIG. 2, the planet gears 86 are coupled to a camshaft 94 of the drive assembly 70 such that the camshaft 94 acts as a planet carrier. Accordingly, rotation of the output shaft 50 rotates the planet gears 86, which then advance along the inner circumference of the ring gear 90 and thereby rotate the camshaft 94. In the illustrated embodiment, the camshaft 94 includes a through-hole 96 extending through the camshaft 94 along the axis 54. The through-hole 96 is shaped to accommodate and/or receive at least a portion of the helical pinion 82. In the illustrated embodiment, the through-hole 96 extends through the entire length of the camshaft 94, which reduces the weight of the camshaft 94; however, the through-hole 96 may extend only partially through the camshaft 94 in other embodiments.

In the illustrated embodiment, the output shaft 50 is rotatably supported by a first or forward bearing 98 and a second or rear bearing 102. Stated another way, the forward bearing 98 is configured to support the output shaft 50 for rotation about the axis 54. The rear bearing 102 is configured to support the output shaft 50 for rotation about the axis 54. The forward bearing 98 is configured to support the output shaft 50 on a side of the motor 42 opposite from the rear bearing 102. The output shaft 50 extends through an opening in the dividing wall 113. The helical-type gears/pinions 82, 86, 90 of the gear assembly 66 may advantageously provide higher torque capacity and quieter operation than spur gears, for example, but the helical engagement between the helical pinion 82 and the planet gears 86 produces an axial thrust load on the output shaft 50. Accordingly, the impact wrench 10 includes a hub or bearing retainer 106, integrally formed by the clamshell halves 28a, 28b, which secures the rear bearing 102 both axially (e.g., against forces transmitted along the axis 54 in either or both directions) and radially (i.e. against forces transmitted in a radial direction of the output shaft 50). In other words, the rear bearing 102 is received in the bearing retainer 106.

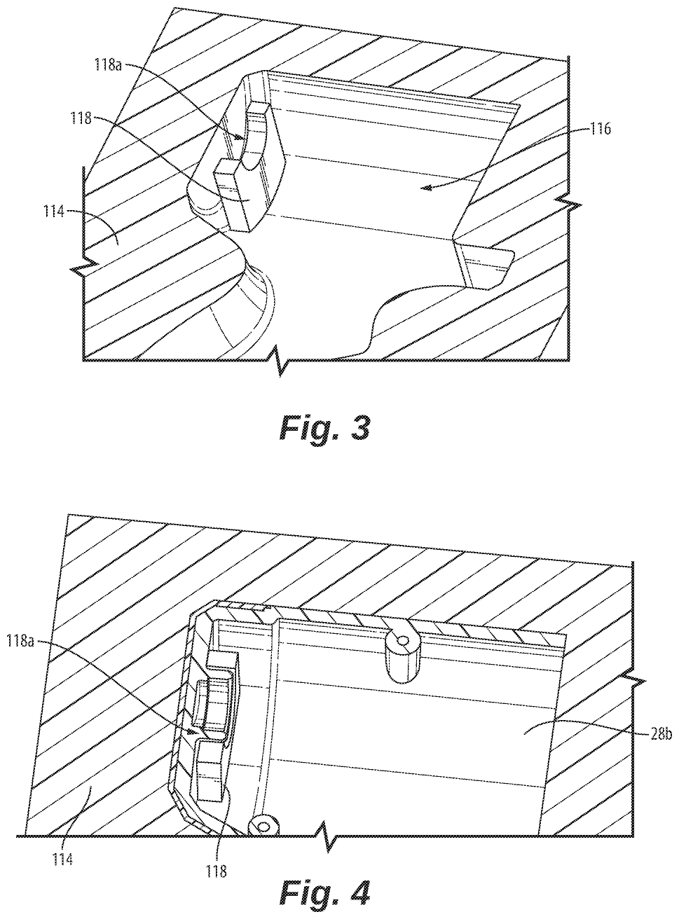

Now referring to FIGS. 3 and 4, each of the clamshell halves 28a, 28b, and thus the bearing retainer 106, may be formed by injection molding a polymer into a mold 114. In other words, each of the first housing portion 28a and the second housing portion 28b is formed through molding such that a first bearing retainer portion 106a and a second bearing retainer portion 106b are formed through molding. Although only one half of the mold 114 is illustrated in FIGS. 3 and 4, description of the mold 114 and the molding process applies equally to both halves of the mold 114 used to form the clamshell halves 28a, 28b. As first mold forms the first housing portion 28a, such that the mold 114 illustrated in FIGS. 3 and 4 is a second mold 114 for forming the second housing portion 28b. The first mold and the second mold 114 are mirror images of each other.

Each mold 114 includes a cavity 116 for the corresponding clamshell half 28a, 28b, each cavity 116 having a profile that is substantially similar to the shape of the associated clamshell half 28a, 28b as described above with reference to the housing 14 (FIG. 1). Each mold 114 further includes a protrusion 118 that extends laterally through the cavity 116 of the mold 114. The protrusion 118 includes an end 118a having an arcuate shape. In the illustrated embodiment, the end 118a of the protrusion 118 is semi-circular.

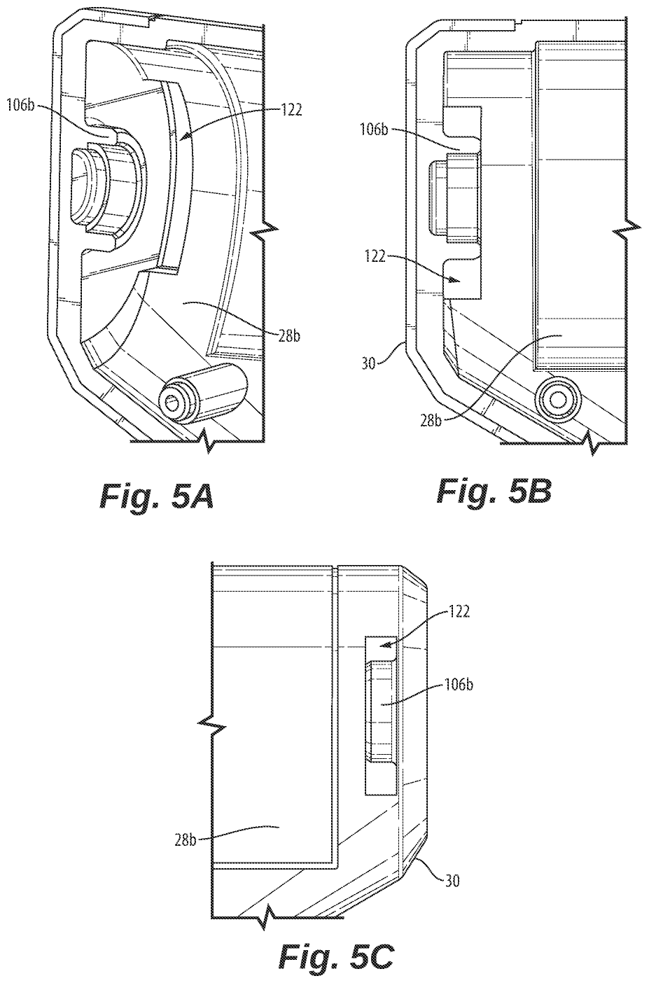

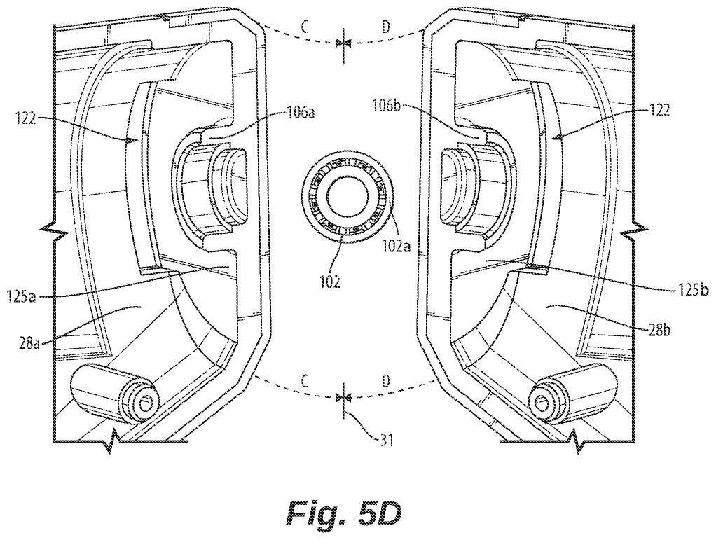

During a molding process for forming the clamshell halves 28a, 28b, each of the clamshell halves 28a, 28b is molded around the protrusion 118. (FIG. 4). The semi-circular shaped end 118a of the protrusion 118 forms and supports the bearing retainer half or portion 106a, 106b in each of the clamshell halves 28a, 28b during the molding process (FIG. 5D). That is, the first housing portion 28a includes first bearing retainer portion 106a, and the second housing portion 28b includes second bearing retainer portion 106b. Each bearing retainer half 106a, 106b has a generally semi-circular shape such that the bearing retainer 106 is circular. As best illustrated in FIGS. 5A-5C, upon removal of each respective clamshell half 28a, 28b from the respective mold 114 (when the molding process is completed), the protrusion 118 is withdrawn through a side opening 122, formed by the body of the protrusion 118 in a lateral side of each of the clamshell halves 28a, 28b. As such, each of the first housing portion 28a and the second housing portion 28b includes a side opening 122 formed at a position that is radially outward of the bearing retainer 106.

Referring to FIG. 5D, the rear bearing 102 is inserted into the bearing retainer 106 by assembling the two clamshell halves 28a, 28b together around the rear bearing 102 (e.g., bringing the clamshell halves 28a, 28b together in the directions of arrows C and D until they meet at interface 31). The clamshell halves 28a, 28b are fastened, or attached, together, and each bearing retainer half 106a, 106b engages the other bearing retainer half 106a, 106b to form the bearing retainer 106. In other words, the second housing portion 28b is attached to the first housing portion 28a such that the first bearing retainer portion 106a and the second bearing retainer portion 106b form the bearing retainer 106. Therefore, the bearing retainer 106 is generally circular and is capable of a receiving and retaining the bearing 102. In other embodiments, the clamshell halves 28a, 28b may be assembled together first, and then the rear bearing 102 may then be pressed into the bearing retainer 106. When the bearing 102 is secured in the bearing retainer 106, an outer race 102a of the bearing 102 rests against an inner periphery of the bearing retainer 106.

The molding process of the bearing retainer halves 106a, 106b advantageously cantilevers each of the bearing retainer halves 106a, 106b from a respective rear wall half or portion 125a, 125b of each of the clamshell halves 28a, 28b. That is, each of the bearing retainer portions 106a, 106b extends from and is supported only by the respective rear wall portion 125a, 125b, without any ribs, walls, etc., to otherwise support the bearing retainer 106. Stated another way, the first housing portion 28a has a first rear wall portion 125a such that the first bearing retainer portion 106a is cantilevered from the first rear wall portion 125a, and the second housing portion 28b has a second rear wall portion 125b such that the second bearing retainer portion 106b is cantilevered from the second rear wall portion 125b. When the clamshell halves 28a, 28b are coupled together, the first rear wall portion 125a and the second rear wall portion 125b form a rear wall 125 (FIG. 2). As such, the bearing retainer 106 is cantilevered from the rear wall 125. By eliminating the need for additional support members for the bearing retainer 106, the axial length of the impact wrench 10 can be reduced. In addition, because the bearing retainer 106 is integrally formed with the clamshell halves 28a, 28b, the housing 14 can advantageously be formed without requiring a separate rear end cap.

With reference to FIG. 2, in the illustrated embodiment, the fan 58 includes a recess 123. Because the bearing retainer 106 is cantilevered from the rear wall 125, the bearing retainer 106 is able to extend into the recess 123 such that at least a portion of the bearing retainer 106 and at least a portion of the rear bearing 102 overlap the fan 58 along the axis 54. In other words, at least a portion of the fan 58 is located radially between the bearing retainer 106 and the opening 122 of each of the first housing portion 28a and the second housing portion 28b. The overlapping arrangement and positioning of the fan 58 advantageously reduces the axial length of the impact wrench 10. Furthermore, the side openings 122 (FIGS. 5A-D) align with the fan 58, such that a cooling airflow generated by the fan 58 can be exhausted through the side openings 122.

Referring to FIG. 2, the forward bearing 98 supports the output shaft 50 and, because the motor 42 does not require a sensor board on its front face, the forward bearing 98 is able to be axially recessed in the stator 46. In the illustrated embodiment, the ring gear 90 includes a boss 115 extending rearwardly through the opening in the dividing wall 113 and forming a bearing support that receives and supports the forward bearing 98. In other words, the forward bearing 98 is coupled to and supported by the ring gear 90 (e.g., at an outer race of the forward bearing 98), such that a portion 115 of the ring gear 90 extends between the housing 14 and the forward bearing 98 in a radial direction of the bearing 98. In this manner, the housing 14, ring gear 90, forward bearing 98 and output shaft 50 each overlap along the axis 54. In other words, at least one line can be drawn in a radially outward direction from the output shaft 50 that intersects the forward bearing 98, the stator 46, and the boss 115 or bearing support of the ring gear 90. This overlapping arrangement advantageously reduces the axial length of the impact wrench 10 and is again facilitated by the lack of a sensor board at the front side of the motor 42.

The drive assembly 70 of the impact wrench 10 will now be described with reference to FIGS. 2 and 3. The drive assembly 70 includes an anvil 126, extending from the front housing portion 22, to which a tool element (not shown) can be coupled for performing work on a workpiece (e.g., a fastener). The drive assembly 70 is configured to convert the constant rotational force or torque provided by the gear assembly 66 to a striking rotational force or intermittent applications of torque to the anvil 126 when the reaction torque on the anvil 126 (e.g., due to engagement between the tool element and a fastener being worked upon) exceeds a certain threshold. In the illustrated embodiment of the impact wrench 10, the drive assembly 70 includes the camshaft 94, a hammer 130 supported on and axially slidable relative to the camshaft 94, and the anvil 126. Stated another way, the hammer 130 is configured to reciprocate axially along the camshaft 94 to impart rotational impacts to the anvil 126 in response to rotation of the camshaft 94.

The through-hole 96 of the camshaft 94 extends into the anvil 126 (e.g., into a bore, inner recess, and/or the like) and opens up to an anvil ball 128 positioned within the anvil 126. The camshaft 94 contacts the anvil ball 128 such that the anvil ball 128 provides a wear contact between the camshaft 94 and the anvil 126 to prevent over-wear to the anvil. In some embodiments, the anvil ball 128 has a diameter of approximately 5.00-15.00 mm. In the illustrated embodiment, the anvil ball 128 has a diameter of approximately 10.00 mm.

With continued reference to FIG. 2, the drive assembly 70 further includes a spring 134 biasing the hammer 130 toward the front of the impact wrench 10 (e.g., in the right direction of FIG. 2). In other words, the spring 134 biases the hammer 130 in an axial direction toward the anvil 126, along the axis 54. A thrust bearing 138 and a thrust washer 142 are positioned between the spring 134 and the hammer 130. The thrust bearing 138 and the thrust washer 142 allow for the spring 134 and the camshaft 94 to continue to rotate relative to the hammer 130 after each impact strike when lugs (not shown) on the hammer 130 engage with corresponding anvil lugs 146 and rotation of the hammer 130 momentarily stops.

The camshaft 94 further includes cam grooves 150 in which corresponding cam balls 154 are received. The cam balls 154 are in driving engagement with the hammer 130 and movement of the cam balls 154 within the cam grooves 150 allows for relative axial movement of the hammer 130 along the camshaft 94 when the hammer lugs and the anvil lugs 146 are engaged and the camshaft 94 continues to rotate.

In the illustrated embodiment, with continued reference to FIG. 2, the impact wrench 10 further includes a bushing 158 supported by the housing 14 between the camshaft 94 and the gear assembly 66. The bushing 158 receives a washer or wear ring 162 positioned in a relief space or annular groove formed by a rear end portion of the camshaft 94. Like the gear assembly 66 being supported in the groove 75 formed by the clamshell halves 28a, 28b, the bushing 158 is supported in a groove 166 formed by the clamshell halves 28a, 28b. In other words, each of the first and second housing portions 28a, 28b form a first groove (e.g., groove 75) configured to directly receive the gear assembly 66 and a second groove (e.g., groove 166) configured to directly receive the bushing 158. The bushing 158 is thus positioned in and constrained by the housing 14 to absorb a rearward force generated by the spring 134 against the camshaft 94. In some embodiments, the bushing 158 may abut a front surface of the ring gear 90.

While typical impact-type power tools include a camshaft bearing to rotationally support a camshaft within a gear case, the cantilevered planet gears 86 radially support and the bushing 158 axially supports the rear end of the camshaft 94 in the illustrated embodiment, which results in an overall length reduction of the impact wrench 10 relative such typical power tools. Specifically, such bearings of typical impact-type power tools include balls contained between inner and outer races such that the bearing must be at least as long or wide as the diameter of the balls. These bearings also require support from bearing retainers, which even further increases a depth or length of the bearing assembly and thus the tool. Obviating such camshaft bearings may also increase a torque-to-length ratio and reduce an overall weight of the impact wrench 10 relative typical impact-type power tools.

In some embodiments, an overall length OL of the impact wrench 10 may be between approximately 175.00 mm and approximately 205.00 mm (e.g., 187.96 mm). The features and dimensions of the impact wrench 10, as described above, allow the impact wrench 10 to be both compact and lightweight. The illustrated impact wrench has a total weight, not including the battery 34, between 5.0 and 5.4 pounds in some embodiments, or between 5.0 and 5.2 pounds in some embodiments. Furthermore, the impact wrench 10 is capable of delivering at least 1,000 ft-lbs. of fastening torque to a workpiece in some embodiments, or at least 1,100 ft-lbs. of fastening torque in other embodiments. Thus, the impact wrench 10 may be capable of delivering between 185 ft-lbs. and 220 ft-lbs. of fastening torque per pound of weight.

In operation of the impact wrench 10, an operator depresses the switch 62 to activate the motor 42, which continuously drives the gear assembly 66 and the camshaft 94 via the output shaft 50. The helical engagement between the helical pinion 82 and the planet gears 86 produces a forward-directed thrust load along the axis 54 of the output shaft 50 (e.g., toward the drive assembly 70), which is transmitted to the rear bearing 102, which is secured against this thrust load by the bearing retainer 106 and/or housing 14.

As the camshaft 94 rotates, the cam balls 154 drive the hammer 130 to co-rotate with the camshaft 94, and the drive surfaces of hammer lugs to engage, respectively, the driven surfaces of anvil lugs 146 to provide an impact and to rotatably drive the anvil 126 and the tool element. After each impact, the hammer 130 moves or slides rearward along the camshaft 94, away from the anvil 126, so that the hammer lugs disengage the anvil lugs 146.

As the hammer 130 moves rearward, the cam balls 154 situated in the respective cam grooves 150 in the camshaft 94 move rearward in the cam grooves 150. The spring 134 stores some of the rearward energy of the hammer 130 to provide a return mechanism for the hammer 130. After the hammer lugs disengage the respective anvil lugs 146, the hammer 130 continues to rotate and moves or slides forwardly, toward the anvil 126, as the spring 134 releases its stored energy, until the drive surfaces of the hammer lugs re-engage the driven surfaces of the anvil lugs 146 to cause another impact.

A method of manufacturing the power tool 10 is described below. Although the method of manufacturing the power tool 10 is described with respect to certain steps, the method may include fewer or more steps than presented in the following description. Further, the order in which the steps are presented does not necessitate that the steps are performed in said order. With reference to FIGS. 3-5D, the method of manufacturing the power tool 10 includes, in a first step, providing the first mold and the second mold 114. Each of the first mold and the second mold 114 defines a cavity 116 and includes a protrusion 118 that extends through the cavity 116. In a second step, the method includes injection molding a polymer into the first mold to form the first housing portion 28a. Injection molding the polymer into the first mold forms the first bearing retainer portion 106a on the first housing portion 28a. Injection molding the polymer into the first mold to form the first housing portion 28a also includes forming the first rear wall portion 125a such that the first bearing retainer portion 106a is cantilevered from the first rear wall portion 125a. In a third step, the method includes injection molding a polymer into the second mold 114 to form the second housing portion 28b. Injection molding the polymer into the second mold 114 forms the second bearing retainer portion 106b on the second housing portion 28b. Injection molding the polymer into the second mold 114 to form the second housing portion 28b also includes forming the second rear wall portion 125b such that the second bearing retainer portion 106b is cantilevered from the second rear wall portion 125b.

Once the first housing portion 28a and the second housing portion 28b have been formed, the first housing portion 28a is removed from the first mold, and the second housing portion 28b is removed from the second mold 114. By removing the first housing portion 28a from the first mold, the opening 122 is created in the first housing portion 28a by the protrusion 118 of the first mold. By removing the second housing portion 28b from the second mold 114, the opening 122 is created in the second housing portion 28b by the protrusion of the second mold 114. With the housing portions 28a, 28b removed from the respective molds 114, the first housing portion 28a is then attached with the second housing portion 28b such that the first bearing retainer portion 106a and the second bearing retainer portion 106b form the bearing retainer 106. As the first housing portion 28a is attached with the second housing portion 28b, the bearing 102 may be placed between the first housing portion 28a and the second housing portion 28b such that the first bearing retainer portion 106a and the second bearing retainer portion 106b join to form the bearing retainer 106 directly around the bearing 102. In other embodiments, the bearing 102 may be inserted into the bearing retainer 106 after the bearing retainer 106 has been formed.

Once the housing portions 28a, 28b have been formed, and the bearing 102 is located in the bearing retainer 102, the method further includes providing the motor 42, the output shaft 50, and the fan 58 mounted to the output shaft 50. The output shaft 50 may then be inserted into the bearing 102 such that the bearing 102 supports the output shaft 54. With the output shaft 50 secured in place relative to the bearing 102, the output shaft 50 may then be operationally coupled with the gear assembly 66 which may be operationally coupled with the drive assembly 70. Further, the housing portions 28a, 28b may be coupled with the front housing portion 22.

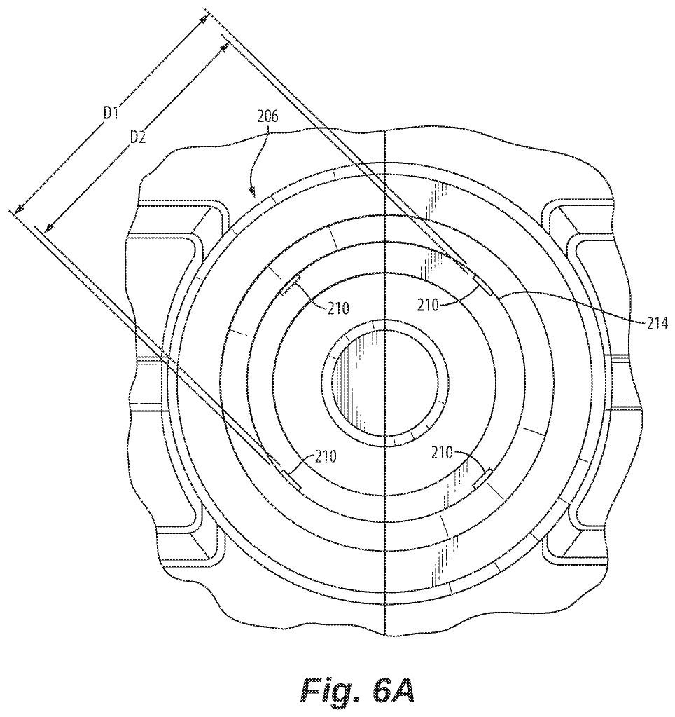

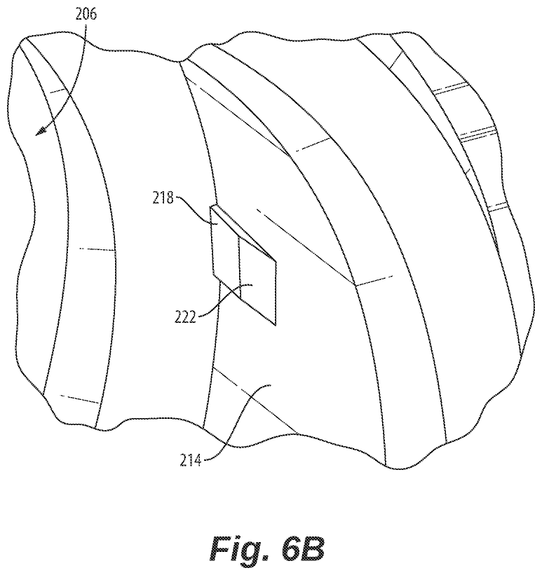

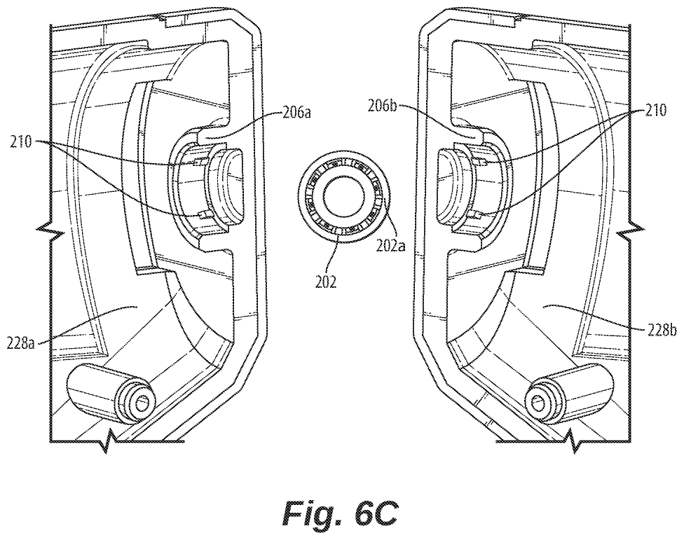

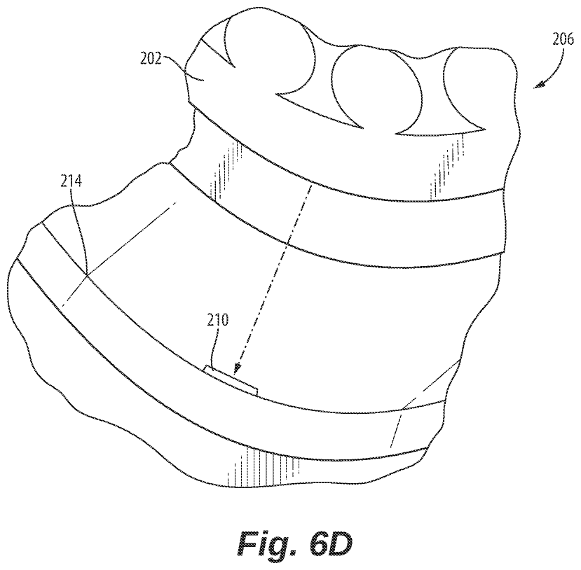

FIGS. 6A-6D illustrate another embodiment of a bearing retainer 206. The bearing retainer 206 is substantially similar to the bearing retainer 106 illustrated in FIGS. 5A-5D except for the differences described herein. As illustrated in FIGS. 6A and 6B, the bearing retainer 206 is formed with a plurality of retainer protrusions 210 disposed around an inner periphery 214 of the bearing retainer 206. In the illustrated embodiment, the bearing retainer 206 includes four retainer protrusions 210. The four retainer protrusions 210 are equally spaced around the inner periphery 214 of the bearing retainer 206. In other embodiments, the plurality of retainer protrusions 210 may include a greater or lesser number of retainer protrusions 210.

Each of the illustrated retainer protrusions 210 includes a first retainer protrusion portion 218 and a second retainer protrusion portion 222. The first retainer protrusion portion 218 extends generally parallel with the inner periphery 214 of the bearing retainer 206. The second retainer protrusion portion 222 is angled relative to the first retainer protrusion portion 218 and converges toward the inner periphery 214 of the bearing retainer 206 in a rearward to forward direction. As such, the second retainer protrusion portion 222 of each retainer protrusion 210 forms a ramp that transitions from the inner periphery 214 of the bearing retainer 206 to the first retainer protrusion portion 218.

As best illustrated in FIG. 6A, the inner periphery 214 of the bearing retainer 206 defines a first diameter D1. The retainer protrusions 210 define a second diameter D2 (prior to insertion of a bearing 202 into the bearing retainer 206). As such, the second diameter D2 is less than the first diameter D1. In some embodiments, the second diameter D2 may be about 1 mm less than the first diameter D1. In other embodiments, the second diameter D2 may be about 0.5 mm less than the first diameter D1. In other embodiments, the second diameter D2 may be about 0.25 mm less than the first diameter D1. In some embodiments, the second diameter D2 may be between 2 mm and 0.25 mm less than the first diameter D1.

Assembly of the bearing retainer 206 in the embodiment of FIGS. 6A-6D is substantially similar to assembly of the power tool of FIGS. 5A-5D. As such, with reference to FIGS. 6C and 6D, the rear bearing 202 is inserted into the bearing retainer 206 by assembling two clamshell halves or housing portions 228a, 228b together around the rear bearing 202. As the rear bearing 202 is pressed into the bearing retainer portions 206a, 206b, an outer race 202a of the rear bearing 202 may slide along the ramp-shaped second portions 222 (FIG. 6B), causing the rear bearing 202 to compress the retainer protrusions 210. Alternatively, the rear bearing 202 may directly engage the first retainer protrusion portion 218 (FIG. 6B) as the housing portions 228a, 228b are assembled. In some embodiments, the retainer protrusions 210 are at least partially crushed (i.e., plastically deformed) during pressing of the rear bearing 202. Once the rear bearing 202 is fully seated within the bearing retainer 206, the compressed retainer protrusions 210 increase friction and therefore the strength of the connection between the outer race 202a of the rear bearing 202 and the bearing retainer 206. As such, the retainer protrusions 210 engage the outer race 202a of the rear bearing 202 to more securely seat the rear bearing 202, thereby reducing noise emissions and vibrations generated from the rear bearing 202

Various features and aspects of the present disclosure are set forth in the following claims.

1. A power tool comprising:
a housing including
a first housing portion having a first bearing retainer portion, and
a second housing portion having a second bearing retainer portion, the second housing portion attached to the first housing portion such that the first bearing retainer portion and the second bearing retainer portion form a bearing retainer;
a motor supported within the housing, the motor including an output shaft defining an axis; and
a bearing received in the bearing retainer, the bearing configured to support the output shaft for rotation about the axis.

2. The power tool of claim 1, wherein each of the first housing portion and the second housing portion includes an opening formed at a position that is radially outward of the bearing retainer.

3. The power tool of claim 2, further comprising a fan mounted on the output shaft of the motor for rotation with the output shaft, and wherein at least a portion of the fan is located radially between the bearing retainer and the opening of the first housing portion and another portion of the fan is located radially between the bearing retainer and the opening of the second housing portion.

4. The power tool of claim 2, wherein the bearing is a rear bearing, and wherein the power tool further comprises a forward bearing configured to support the output shaft on a side of the motor opposite from the rear bearing.

5. The power tool of claim 1, wherein each of the first housing portion and the second housing portion is formed through molding such that each of the first bearing retainer portion and the second bearing retainer portion is formed through molding.

6. The power tool of claim 1, wherein the first housing portion has a first rear wall portion such that the first bearing retainer portion is cantilevered from the first rear wall portion, and the second housing portion has a second rear wall portion such that the second bearing retainer portion is cantilevered from the second rear wall portion.

7. The power tool of claim 1, wherein a plurality of retainer protrusions is formed on an inner periphery of the bearing retainer, and wherein the plurality of retainer protrusions engages the bearing to mitigate noise emissions generated from rotation of the motor.

8. The power tool of claim 7, wherein the bearing is configured to plastically deform the plurality of retainer protrusions.

9. The power tool of claim 1, wherein each of the first bearing retainer portion and the second bearing retainer portion is substantially semi-circular such that the bearing retainer is circular

10. A power tool comprising:
a housing;
a motor supported within the housing, the motor including an output shaft defining an axis;
a bearing configured to support the output shaft for rotation about the axis, the bearing including an outer race; and
a bearing retainer configured to receive the bearing, the bearing retainer including a plurality of retainer protrusions that extend from an inner periphery of the bearing retainer,
wherein the outer race of the bearing is pressed into the bearing retainer such that the retainer protrusions are plastically deformed by the outer race of the bearing.

11. The power tool of claim 10, wherein each of the plurality of protrusions includes a first retainer protrusion portion and a second retainer protrusion portion, and wherein the second retainer protrusion portion is angled relative to the first retainer protrusion portion and converges toward the inner periphery of the bearing retainer.

12. The power tool of claim 10, wherein the bearing retainer is cantilevered from a rear wall of the housing.

13. The power tool of claim 10, wherein the bearing is a rear bearing, the power tool further comprising a forward bearing positioned on a side of the motor opposite from the rear bearing.

14. The power tool of claim 10, wherein the housing is formed through molding such that the bearing retainer is formed through molding.

15. The power tool of claim 10, further comprising
a camshaft rotationally driven by the motor,
a hammer configured to reciprocate along the camshaft, and
an anvil configured to receive impacts from the hammer and configured to apply torque to a workpiece.

16. A method of manufacturing a power tool, the method comprising:
providing a first mold and a second mold, each of the first mold and the second mold defining a cavity and including a protrusion that extends through the cavity;
injection molding a polymer into the first mold to form a first housing portion, the first housing portion including a first bearing retainer portion formed by the protrusion of the first mold;
injection molding a polymer into the second mold to form a second housing portion, the second housing portion including a second bearing retainer portion formed by the protrusion of the second mold;
removing the first housing portion from the first mold and removing the second housing portion from the second mold; and
attaching the first housing portion with the second housing portion such that the first bearing retainer portion and the second bearing retainer portion form a bearing retainer configured to support a bearing.

17. The method of claim 16, wherein attaching the first housing portion with the second housing portion includes placing a bearing between the first housing portion and the second housing portion such that the first bearing retainer portion and the second bearing retainer portion form the bearing retainer around the bearing.

18. The method of claim 16, wherein removing the first housing portion from the first mold forms an opening in the first housing portion and removing the second housing portion from the second mold forms an opening in the second housing portion, and wherein the opening of each of the first housing portion and the second housing portion is located at a position radially outward of the first bearing retainer portion and the second bearing retainer portion, respectively.

19. The method of claim 18, further comprising providing a motor having an output shaft and a fan mounted to the output shaft, and inserting the output shaft into the bearing such that the bearing supports the output shaft, and wherein the fan is mounted to the output shaft at a position such that at least a portion of the fan is located radially between the first bearing retainer portion and the opening in the first housing portion, and another portion of the fan is located radially between the second bearing retainer portion and the opening in the second housing portion.

20. The method of claim 16, wherein injection molding a polymer into the first mold to form the first housing portion includes forming a first rear wall portion, and injection molding a polymer into the second mold to form the second housing portion includes forming a second rear wall portion such that the first bearing retainer portion and the second bearing retainer portion are cantilevered from the first rear wall portion and the second rear wall portion, respectively.
